(19) United States
(12) Patent Application Publication
(10) Pub. No.: US 2008/0010136 A1
(43) Pub. Date: Jan. 10, 2008

(54) ELECTRONIC BOOK MANAGEMENT SYSTEM AND ITS METHOD

(76) Inventor: Chun-Yao Yu, Taichung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/456,427

(22) Filed: Jul. 10, 2006

(51) Int. Cl. G06Q 30/00

(52) U.S. Cl. 705/14

(57) ABSTRACT

A electronic library management system and its method, which comprises three main advantages: A. collecting booklists automatically: which can break through the traditional technology of manual controlling, connect to each network bookstore by using single window connecting way so as to collect and excerpt the booklists; B. checking duplicate automatically: also break through the traditional technology of manual controlling, which can connected the collected booklists to the ERP system of the library so as to check the duplicate; C. replied automatically: also break through the traditional technology of manual controlling, which can replied to the recommender automatically during purchasing and after being entered the library. By the above-mentioned advantages, and through the Internet so as to recommend, manage and maintain the books, thus replacing the traditional technology of manual controlling, and reducing the wasting of manpower and improving the processing pace, and creating the three win aspect of reporter, recommender and the books supplier.

### BACKGROUND OF THE INVENTION

1. Field of the Invention

The present invention relates to an E typed book recommendation, management and maintenance, and more particularly to an electronic library management system and its method which replace the ordinary man-made operating way by internet way so as to reach E typed book recommendation, management and maintenance.

2. Description of the Prior Art

For the conventional recommended end, before the Internet has not prevailed or has entered the Internet period but the technology not yet breaks through, library recommender only can passively fill in the books recommendation list prepared by the library or provide simple passive homepage, then the recommender fill in his/her recommended books that he/she hope the library to purchase by means of the broken memory or the incomplete information.

In addition, the reporter end has some disadvantages described as follows:

Firstly, since the information filled by most of the recommenders is wrong and incomplete, the confirmation of the recommended booklist or the collection of the booklist has consumed large amount of manpower and time.

Secondly, once the recommended booklist has confirmed or collected, massive manpower must be spend again to check the collection immediately whether there has duplicate, then spends the massive time to reply the recommender the following processing status of the books, which is very troublesome. However, the recommender is only needed to know the processing status of the recommended books by the reply of the reporters, which is impossible before this invention, because the manual operating way forever could not achieve the standard of reply immediately.

The present invention has arisen to mitigate and/or obviate the afore-described disadvantages.

### SUMMARY OF THE INVENTION

The primary objective of the present invention is to provide a electronic library management system and its method, wherein penetrating Internet way, and by the affiliation of the operation connection of the recommender end, the system maintenance connection of the administer end and the connection of the system maintainer end, and by cooperating with the each large network bookstore, thus obtaining times of reducing booklist purchase collection, duplicate controls and the following processing status repayment, and promotes the interaction with readers and create competing superiority so as to avoid process the same thing repeatedly by consuming more time and manpower.

The further objective of the present invention is to provide a electronic library management system and its method, wherein this system can reduce books purchasing flow, enhance working efficiency and realize booklist collection, thus achieving the status reply immediately, and purchasing the correct books to the recommender in the shortest time, and providing the biggest benefit and the quickest service under the least manpower and costs.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of an embodiment of an electronic library management system and its method in accordance with the present invention;

FIG. 2 is the perspective view of a second embodiment of the electronic library management system and its method in accordance with the present invention;

FIG. 3 is the perspective view of another embodiment of the electronic library management system and its method in accordance with the present invention; and

FIG. 4 is the perspective view of a further embodiment of the electronic library management system and its method in accordance with the present invention.

### DETAILED DESCRIPTION OF THE PREFERRED EMBODIMENTS

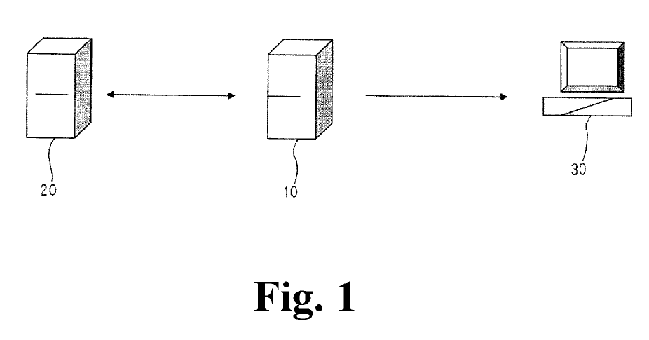

Referring to FIG. 1, a electronic library management system and its method in accordance with the present invention generally utilizes three-layer type main and sub frames to form the frame of the database and the management system. The electronic book management system comprises a Microsoft windows 2000 server, a Microsoft SQL 2000 server 20 and a user end 30.

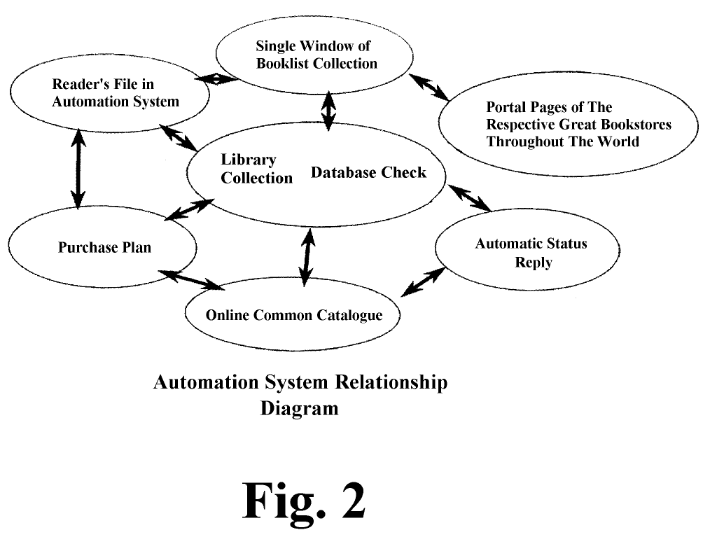

Referring to FIG. 2, the electronic library management system and its method in accordance with the present invention comprises three module functions: collecting single window automatic booklist, checking books copies and statistics form of automatic state reply parameters. The modules can be worked and share data simultaneously, and by cooperating with the user server or user data files of automation system in the library, the user files can be unified and maintained simultaneously.

When each parameter data of the system is established, this invention can provide inquiry immediately, and can share with the user files of the automation system without establish again. When the user's data in the automation system is changed, the system can be updated automatically, and the system can convert the book information between CCCII, BIG5 and UNICODE. Furthermore, the system can offline reproduce word files, excel files, ISO2709 files and 2-dimensional barcode in a multi-task/multi-user environment. And through the Internet browser, unlimited number of users can simultaneously use different modules online.

In addition, the electronic library management system and its method in accordance with the present invention is capable of dealing with Chinese, Japanese, Korean and English. And the innovativeness of this invention is its Chinese processing capability, for instance, the system accepts different book information in CCCII, BIG5 and UNICODE online.

In order to ensure the safety of the data, the system can establish and maintain the USERs of following items: basic orders, password, start module and executable functions of various modules. The system cancan set the start module and the executable functions of various modules according to the account number of the users, can also establish authority level of users of each subordinate library or the cooperative library, and non-authorized users are unable to access the operation module of other libraries. The system can count the number of loading cycles, time of use, the situation of the respective subsystems, and can find out which unit the user belongs to according to the uploaded password of the users. The system can record by whom a specific file is created, added or deleted, updated, date of execution, and all the changes made to the file. The system includes backup system, recovery system and support system. The function of backup should include the routine backup work, recording all data of change and the backup work executed at request or in an emergency. The system is provided with backup and recovery utility programs so as to improve security and integrity. The backup function includes material file, procedure file, system file and so on. The system includes a dual-host redundant data acquisition device (this is also the innovative technology of the present invention), and can set the operation mode of the common system shared by the subordinate libraries or the related libraries. This system includes the network online operation of total library, subordinate libraries, related libraries and the cooperative libraries. The system of this invention can accept various operation modes of different libraries, for example: different type of purchase orders, the definition of the type of recommenders of the respective purchase order, the ownership of different identities, and default value and the books of different network bookstores can be inquired via a single window simultaneously.

The system of this invention provides the full browser window, and has a prompt function throughout the entire operation process. When the system enters into various modules, the picture of the entered modules can be set as homepage according to the user's preference. The system can provide manual or automatic online edition of real-time update. Furthermore, the system can provide various kinds of examples that contain the functions of establishing different formats of mails transmission and provide a hyperlink for automatic access to the system page.

With respect to the maintenance function, the system provides the functions of on-line addition, revision, deletion and transcription of various files, and automatic maintenance of related files. When there is something wrong with the data or operation, the system can find out the mistakes automatically, and refuse to execute the save function by giving an alarm. The system can provide the function of data locking each file is allowed to be revised by only one person at a time, but can be read by multi-people simultaneously. When deleting the data on-line, the system will show a message automatically asking for a confirmation and then the data can be deleted after confirmation. The input and fault detection system is able to find out fault automatically, give an alarm and show the information of the fault, such as wrong code, wrong data format, and improper operation. However, the innovative technique of the present invention is the batch transaction of various data, when transmitting a mail of book purchase order or the status of the library collection status automatically, the transmission cycle can be adjusted by the administrator.

With regard to the data inquiry, the system of the present invention allows the user to inquire about the recommender, the library collection and the circulation status of each library simultaneously based on the recommended data. Moreover, the system can serve as a recommender or is recommended the booklist retrieval of the books, and provides two conventional retrieval functions.

With regard to the statistical analysis and report output, the system of the present invention provides the functions of on-line, off-line printing and preview, and all the reports can be exported to EXCEL, and can be printed from a specific section labeled with a printing instruction at the user's request. The system can suspend or cancel the print job. The innovative technology lies in that the system provides a settable statistical period, such as daily, weekly, monthly, quarterly, half-yearly, and yearly, in order to count the respective reports in this period, and the statistical reports can be printed by batch processing.

With regard to the system function of the booklist collection module, and for the recommender who has made a search two times or more, the system will retain the input value of the first time so as to facilitate the second time input. Its innovation technology lies in that the files which have already been created by the recommender can be supplemented, deleted, updated, or converted at any time by the administrator. The administrator can choose to renew or cover the original data when converting similar data. The system can tell the country of publication, traditional Chinese, simplified Chinese, the western languages, the Japanese, the continuous publication and so on by the ISBN prefix code. After the large network bookstores are collected, the system will provide a single window to allow the recommended to enter the key word, book title, author, the publisher, and ISBN code of the book to be searched.

The system cancan provide at least the only default portal page for enabling a continuous search continually when the recommender forgets to make a selection, and t the default value of the administrator's adjustable logic sequence is: the database of non-purchase, the database of the recommender, and the automation system library collection database.

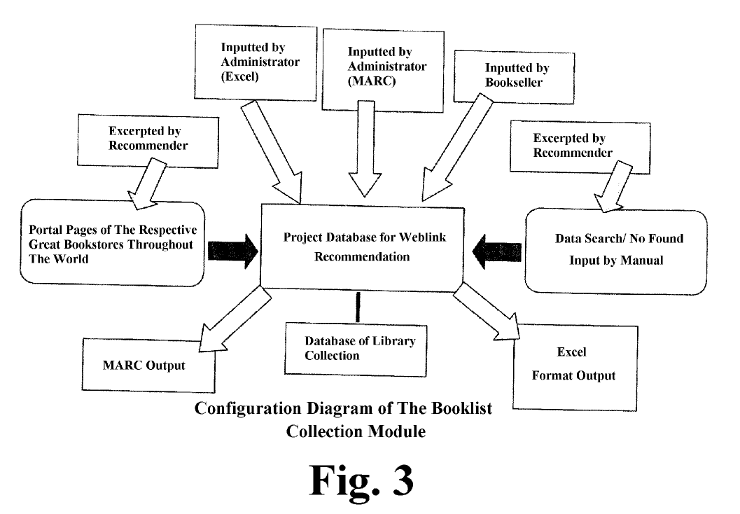

The booklist collection module is shown in FIG. 3.

In terms of operation and function, the system of the present invention provides the booklist data input function and the booklist data can be inputted on-line. It's the innovative technology lies in that the user doesn't have to provide the integral order data, and the system supports the inquiry only by inputting fragments of the order data. When the booklist data is not found, the manual input is needed, and according to the default input fields of the system are set to: author, publisher, ISBN, hardcover, and paperback. The system provides at least the following seven network bookstores of traditional version: Jingshitang, the new classmate, Chengpin, three people, the new silk road, center and Boke. The system provides at least the follow three simplified network bookstores: The Chinese books net, China buy books net, the Chinese modern bookstore. Other languages at least contain the following websites: US network bookstore: MAZON. The network bookstores in Japan include: E-HON national bookstore, three province halls. And the network bookstores in Korea includes: KYOBO. For the prompt messages of the library collection, the system has to display all items of the status areas of all library collections of the automation system, instead of only showing the library collections, and the recommender has the right to hide his/her information. The system provides a selection of hiding or not hiding information. The recommender can email the information to different receivers by entering one or more email addresses no matter the information has been recommended successfully or not. The system provides a hyperlink for automatic access to portal pages, such that it can be hyperlinked to the portal page whether the booklist data is correct or not when booklist searching is failed or the data is in question,. The system can automatically convert the currency of the recommended foreign library into Taiwan dollar and renew the exchange rate every day according to the New York market. The recommender can hyperlink the automation system library collections at any time to check the doubtful recommended booklist. Furthermore, the recommender can leave his/her message on-line for the recommended booklist.

In terms of realtime and batch transfer, the system of the present invention can transfer the exterior tidied-up booklist and accept the booklist in CMARC & USMARC (ISO-2709) or EXCEL format. When transferring the booklist data, the system can choose to cover the same contents or to renew the different contents.

With regard to the data maintenance, the innovative technology lies in that the system is able to transform the booklist from simplified Chinese into traditional Chinese, and the administrator can maintain the recommended booklist manually or batch by batch instead of piece by piece.

With regard to the data inquiry, the booklist access point: the system provides at least an easy mode and an advanced mode. Boolean logic contains (and, or, and not, bigger than, smaller than, the same opening, partial same, completely same), and its innovative technology lies in that the easy mode includes the key word: study year, processing condition, data source, type of language, type of data, status of recommendation, recommendation date and so on. The advanced mode includes: title, ISBN, price, binding, author, the educational system of the recommender, the class of the recommender, the branch of the recommender, study year, processing condition, data source, language, the data type, recommendation condition, recommendation date, publication years and so on.

With regard to the data output, the innovative technology lies in that the system can output magnetic tape or disc in CMARC USMARC format that is provided for backup or exchange, also it must conform to the standard of ISO-2709. The subfield identifier, record separator, separator, are in ISO 646, and the corresponding hex values are 1F, 1E, 1D. The 1E must be added before the record separator 1D, thereby the system can mark at the column of the CMARC 801 in order to know the recommender. The system can convert the recommended booklist into tape and disk in MARC or EXCEL format, for backup or exchange, also it must conform to the standard of ISO-2709, and the code can be in CCCII or BIG5 or UTF-8, etc.

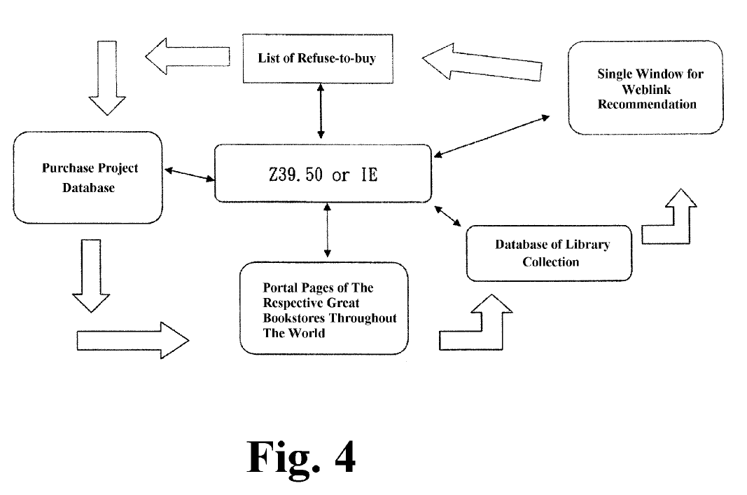

With regard to the duplicate verification module, its innovation technology lies in the system has an automation system platform and can retain the function of processing after replacing the automation system. The refuse-to-buy booklist is the first comparison database, which can be compared to the booklists recommended by other recommenders by stepping purchase order orders, and the administrator can select more than one cross purchase orders. The duplicate comparison is carried out via Z39.50. The status of the recommended books should be prompted to the recommender synchronously, and meanwhile, it should provide a hyperlink for direct access to the WEB of the library so as to facilitate the recommender to verify, such as the system of duplicate verification shown in FIG. 4. The innovative technology lies in that the input of the refuse-to-buy booklist, the administrator can establish the booklist of the refuse-to-buy step by step, and can batch-by-batch input the record of the refuse-to-buy booklist in fixed format (ISO2709 or EXCEL). The filtering scope of a single list will be enlarged if the input content is curt, and the filtering scope will be narrowed if the input content is detailed. The administrator can set the valid date or the defrosting date of the refuse-to-buy list, and the setting of the new purchaseorder order, and its functions can be adjusted by parameters. The parameter includes: title of the purchase order, effective period of the purchase order, total fund of the purchase order and the option of limiting the fund. The identity of the recommender includes: educational system, group, department, division, section, teaching and administrative staff, student, and former student. Each identity has an exclusive picture and has a parameter option in the administrator port, option of allowing for recommendation of duplicate book, status bar or adjustable class of the status bar authorized to be shown on the recommender's page, the optional duplicate comparison between the purchase orders, and comparison option that can automatically trace back to the newly added purchase orders of other administrators. As for the duplicate comparison, automation system the system of the present invention allows for online duplicate comparison, default or designated sequence of the duplicate comparison, without changing any existing setting of the automation system. The data field collected by the respective network bookstores includes at least the following items: book title, author, publishing house, price, ISBN, publication date, binding and source. The data field of the determined books includes at least: book title, author, price, ISBN, publication date, binding, source, recommender, times of recommendation, recommendation date, processing status, title of the purchase order, instruction of the purchase order, fund of the purchase order, total amount of the already recommended books, date of beginning and end. The method of comparing the duplicate and the automatic status reporting can judge the duplicate generally based on ISBN. If there is no ISBN, the book title, author and the space of the publisher are retained. In the automatic duplicate auditing, any items in the status bar of the library collection can be transmitted back to the recommender to tell the updated status of the book, and regarding the refuse-to-buy book, it also can tell the recommender the reason of refusing to buy and the unfreezing date. When the latest processing status of all the recommended books are changed, the system can inform the recommender automatically instead of manually by email the latest information. Also, the administrator can inform the recommender the latest status of the recommend book manually. All the recommendations can be compared with one another, and the administrator can respond to the messages of the recommenders one by one or batch by batch automatically.

With regard to the parameter setting and the report statistic module, the innovative technology lies in that the parameter can be adjusted and the report can be analyzed at any time by the administrator.

Regarding the operation, its basic parameter must contain the following items: the adjustable name of the addresser, the adjustable mailbox of the addresser, the adjustable SMTP (Simple Mail Transfer Protocol) sever, the adjustable route of the home page, the default value adjustable default value of the home page, the adjustable SCRIPTS route, the adjustable default value of the SCRIPTS, the adjustable user name, the adjustable address of the school home page, the adjustable address of the library home page. And the system can inform the user the respective services by sending an email automatically. The innovative technology lies in that the processing status schedule is adjustable: the adjustment is executed, the suspendable schedule of the automatic mail transferring status, the user's adjustable post log in home page, the adjustable recommendation record of the user, adjustable projects of hiding or showing the recommended purchase order list, adjustable information of individual recommendation of history demonstration recommendation ratio. If the input of the adjustable recommender data is the necessary field: birthday, education level, occupation, habitation, email, ID card, individual website. Adjustable data origin choice: Taiwan: Jingshitang, the new classmate, Chengpin, three people, the new silk road and center; US: AMAZON; mainland: The Chinese books net, China buy books net, the Chinese modern bookstore; Japan: E-HON national bookstore, three province halls; Korea: KYOBO.

The establishment of its basic phrases had to contain the following items: the education level, occupation, habitation, the educational system, the branch, the status category and the announcing column, and its innovation technology lies in it increased the processing status of the books or the collections and multiple mail transmission models.

With regard to the aspect of the changing of the management, its innovation technology lies in the system can record the following changing attributes, and can inquire further, like changed files: the reader files, the defeat of the recommended files, the successful of the recommend files; changed categories: revises, addition, deletion, changer, changed IP, the instruction of the changing, the changing date and the changed scheduling of the system.

With regard to the aspect of the analysis of the statistical report form, its innovation technology lies in the system can establish following parameters to make statistics: take individual as a unit, take the branch as a unit, take the times of the recommended books as a unit, and take educational system as a unit.

With regard to the aspect of the success rate, its innovation technology lies in the system can establish the processing status of the following recommended books so as to complete statistics of the percentage: successful recommendation, the recommendation of the duplicate, the recommendation of resisting to buy, purchase to the hall, still at processes and has not purchased, out of print.

With the regard to the aspect of its recommendation rate and the recommended history list, its innovation technology lies in the system can establish the processing status of the following recommended books so as to complete list of the percentage: the recommended list of the duplicate, the list of purchase to the hall, the list of processing but has not entered into the library, the list of resisting, and the list of out of print.

For the above-mentioned explanation, this system and its method can reach the following goals:

Firstly, penetrating Internet way, and by the affiliation of the operation connection of the recommender end, the system maintenance connection of the administrator end and the connection of the system maintainer end, and by cooperating with the each large network bookstore, thus obtaining times of reducing booklist purchase collection, duplicate controls and the following processing status repayment, and promotes the interaction with readers and create competing superiority so as to avoid process the same thing repeatedly by consuming more time and manpower.

Secondly, this system can reduce books purchasing flow, enhance working efficiency and realize booklist collection, thus achieving the status reply immediately, and purchasing the correct books to the recommender in the shortest time, and providing the biggest benefit and the quickest service under the least manpower and costs.

While we have shown and described various embodiments in accordance with the present invention, it should be clear to those skilled in the art that further embodiments can be made without departing from the scope of the present invention.

What is claimed is:

1. An electronic library management system and its method, comprising: single or plural operation connection of recommender end that is connected to a system maintenance connection of administrator end by Internet and provided functional option of the recommended books;
at least a system maintenance connection of the administrator end, which is connected to the operation connection of recommender end and a connection of system maintainer end by the Internet, and provided the functional option of system maintenance of the manager, set the functional option that being used by the recommender and chosen entrance website of books searching that provided by the connection of the system maintainer end; and
at least a connection of the system maintainer end, which is connected to the system maintenance connection of the administrator end by the Internet, provided functional option of the system, set the functional option that being used by the recommender and the parameter of the entrance website;
the connection of the operation connection of the recommender end, the system maintenance connection of the administrator end and the connection of the system maintainer end being formed books interview work management system that is provided functions of books purchasing and inquiring and reduced time, manpower and material resources.

2. The electronic library management system and its method as claimed in claim 1, wherein the connection of the operation connection of the recommender end, the system maintenance connection of the administrator end and the connection of the system maintainer end is achieved by Internet or other known transmission agreement connection ways.

3. The electronic library management system and its method, comprising:
recommender, including one to plural users, being landed by the operation connection of the recommender end and entered in reader's database;
reader's database, being able to try again or cancel, providing the recommendation of the historical records individually so as to carry out a table of choosing purchase files;
choosing the purchase files, being provided a table of recommending files and changed all pages by means of pull down menu of other functional options, the table of recommending files is a retailed information of the recommending files; and pointed the option of me to recommend then began recommend;
began recommend is a window of books recommending and being provided the basic data of inquiring books, regarding the material origin choice, firstly the system maintenance connection of the administrator end being decided which entrance website to open for searching, then the recommender decides which entrance website for downloading material through the operation connection of the recommender end, after being decided the system began to search according to the chosen website and carry out the next action:
each large network bookstore, being set the parameter of the connection of the system maintainer end, provided the system maintenance connection of the administrator end to the operation connection of the recommender end, and entered the recommended database and the library database to search the booklist according to the chosen entrance websites;
the recommended database, being decide whether the booklist has recommended or has not recommended by the system, if the booklist has recommended, the system being informed and listed the booklist to the rank list to statistic, and if the booklist has not recommended, the system being connected to the library database;
the library database, being decide whether the booklist has included in the library collection by the system, if the booklist has included in the library collection, the system being informed the existed procedure, and if the booklist has not included in the library collection, the system being accomplished the recommended booklist and entered into the successfully recommended procedure;
successfully recommended, after being recommended successfully, the recommended books being listed in the recommended database as a recommended book, and informed this information to the recommender by mail transmission system;
the connection of the above-mentioned method being formed functions of books purchase and inquiring, and reduced time, manpower and material resources so as to provide the correct information to the recommender and recommend books, buy or borrow the books according to the data showed by the information.

4. The electronic library management system and its method as claimed in claim 3, wherein the individual recommended historical record containing book title, purchase files, quantity, recommendation date, and the showing of purchase status area and the purchase rate, and being sequenced increases progressively or decreases progressively according to the fields (such as book title, purchase files, quantity, recommendation date or purchase status area), when pressed down the book title in the fields, the details of the book including individual recommended booklist data is able to see, and in the bottom of the window being saw the message when recommending the book and the information replied by the administrator.

5. The electronic library management system and its method as claimed in claim 3, wherein the functional sheet of other functional options is able to choose the table of purchasing files and show the table of the recommending files, and is able to see all the recommended purchasing files and the outset date and the expiration date of the purchasing files, the system maintenance connection of the administrator end has the functional options of revision, deletion and addition of purchasing files, however, the recommender of general jurisdiction is unable to see the functional options of revision, deletion and addition, when pressing the name of the purchasing file of the table of the recommending files, the system is entered the purchasing files directly, and checked up the recommended booklist and one of the functional options is able to change the book title from simplified form to traditional form, and provided the revision and deletion of the recommended booklist so as to meet with the need of the recommender, when choosing the book tile, the system is showed the details of the recommended books, provided the recommender to recommend this book directly, and added the system maintenance connection of the administrator end to the functional options of the resist purchasing files, after being added to the resist purchasing files, the processing status of the book is directly changed to resist to purchase forever, this system has provided the function of revision the recommended books, so long as press revision after the book wanted to be recommended that began to revise, and the processing status is represented the status of processing the book at present, if only revise the status to resist purchasing but has not added to the resist purchasing files, then the recommender is still has the right to recommend, and once the book status is changed, the system is informed the book processing status to the recommender automatically, if you want to delete the data of the recommended books, pressed deletion after the list of the recommended books.

6. The electronic library management system and its method as claimed in claim 3, wherein the system provided the basic data of inquiring the books, and the choosing of the data source is determined by the system maintenance connection of the administrator end firstly of deciding which bookstores to inquire, then the recommender decided which bookstore to load data through the operation connection of the recommender end, the bookstore is able to reelection or choose singly, and the system is searched by default value, and the searching value provided four kinds of inquiry: the book title, the author, the publishing house and ISBN, when pressing searching key, the system entered the recommended database for searching the booklist according to the chosen Internet bookstores and turned out the searching results, if you want to examine whether the book is that you wanted to recommend, then press showing the recommended picture of the book title, tick off represented the data of the recommender is not showed in the recommended book, also you can leave a message to the library, and the reply is listed in the detailed booklist of the recommended books.

7. The electronic library management system and its method as claimed in claim 3, wherein in the recommended database, the system provided recommended duplicate control, which is in view of the book title have no ISBN that unable to judge whether the book is a duplicate, and reminds the recommender the recommended books at present and voluntarily judges whether the book is a duplicate so as to avoid the identical book listed in the purchasing files repeatedly.

8. The electronic library management system and its method as claimed in claim 3, wherein if the book is recommended repeatedly, the system is listed the book title in the rank statistics, and provides function of a billboard that is served as the system maintenance connection of the administrator end, at present provides three kinds of billboard: recommended ranking of the recommender, the class and the booklist.

9. The electronic library management system and its method as claimed in claim 3, wherein the table of the recommending files is able to see all the recommended purchasing files and the outset date and the expiration date of the purchasing files, the system maintenance connection of the administrator end has the functional options of revision, deletion and addition of purchasing files, choose the added purchasing files and input the data in the field corresponded to the title in the window directly, the way of writing the date must be accorded to the fixed form such as Aug. 17, 2004, if the form is wrong the system showed that the form is incorrect, regarding whether the system can recommend continually after the expiration date, tick off represented although the purchasing files are terminated, the recommender still can recommend books to the library, pressed the key of store after the data has input, if stored successfully the system showed the information that the recommended purchasing files has stored, at that time the system is returned to the table of the recommending files, and the purchasing files are newly added to the table of the recommending files, if the purchasing files are needed to revise after being input, pressed the key of revision so as to begin revise, and then pressed the key of storing, in the table of the recommending files, each purchasing file is able to delete, pressed the key of deletion then the inquiry window is appeared, after being deleted, the system is informed that the purchasing file has deleted.

10. The electronic library management system and its method as claimed in claim 3, wherein in order to facilitate the system maintenance connection of the administrator end to know the data of the recommended books at present, the system provided the function of collecting the EXCEL order and saved as the EXCEL file, and provided two kind of choices of predetermined code and UNICODE code, and in the collected EXCEL file appeared fields of serial number, book title, author, the publishing house, ISBN, the publication date, the price, new Taiwanese currency (a reference value), bind, the recommended quantity, the recommended date and the recommender.

11. The electronic library management system and its method as claimed in claim 3, wherein in order to facilitate the system maintenance connection of the administrator end, the system is able to change multi ISBN at a time, and provide the function of setting the recommended books altogether that is able to change multi ISBN at a time, and at present has provided two ways, one is input data one by one, and the other is collected the EXCEL file, but the form of the order name must be readable, and the field title must be ISBN and has its corresponded reading form.

12. The electronic library management system and its method as claimed in claim 5, wherein regarding the recommended books added to the resist purchasing files, in order to facilitate the management of the system maintenance connection of the administrator end, chosen the key of resist management in the functional options, the list of the resist purchasing files is showed so as to facilitate the administrator to filter the not purchasing books firstly, if added the resist purchasing books in the list of the resist purchasing files, then chosen the key of added resist purchasing, if chosen resist purchasing forever the date is needn't to input, if the files are stored in the resist purchasing files that cannot be changed in the purchasing files, when added the resist purchasing files, please input ISBN, then the system is able to determine the resist purchasing booklist correctly, and the system is resist directly so as to facilitate the user to recommend, thus reducing the time of revision or deletion of the administrator after the recommendation, and choosing resist purchasing for one time or forever.

13. The electronic library management system and its method as claimed in claim 3, wherein the system provides the recommended message management, including the recommended message list, which is replied altogether or one by one, the entire message contents are showed in the message fields, when pressing the key of reply then entered message reply, and saw the basic data of the books, input the replied message in the message fields and then pressed the key of reply, the recommender saw the replied message in the basic data of the recommended books.

14. The electronic library management system and its method as claimed in claim 13, wherein the recommended message list provides searching functions of simple searching and step searching.

15. The electronic library management system and its method as claimed in claim 3, wherein the system provides the function of member management including member list that showed all the members at present, the administrator is able to add, delete or revise the data of the members, and sequence according to the title column, and provides the searching functions of simple searching and step searching.

16. The electronic library management system and its method as claimed in claim 15, wherein the member list has the function of worked altogether, when choosing the newly added member in the member list, a window is showed, the first half part is to fill in the basic data, the email field must be filled correctly, because the information related to the recommended books are all informed by email after being recommended, and the second half part is right options gave to the members, furthermore, pressed the key of revision in the member list, the window of revising the member data is showed and appeared a choosing field of a fixed password that is chosen according to the requirements.

17. The electronic library management system and its method as claimed in claim 15, wherein the system is able to add member data one by one or altogether, if there exists the basic member data that is selected from the member list and collected to the member data, and collected the EXCEL files, if account number or data appeared repeatedly, the system provides two options, one is skipped that is to say according to the original stored member data, and the other is updated that is to say according to the later collected member data.

18. The electronic library management system and its method as claimed in claim 3, wherein the system provides announcing column management, and the functions of addition, deletion or revision so as to announce the newest information to the announcing column, the functions of addition, deletion or revision only can be implemented in the administrator end, the added information is showed to the top end of the window of the announcing column, and served as a additional file.

19. The electronic library management system and its method as claimed in claim 3, wherein the system provides the function of words management, the values established in the system are commonly used values, the administrator can add, delete or revise depend on the required values.

20. The electronic library management system and its method as claimed in claim 3, wherein the system provides the system setting function of the connection of the system maintainer end including list of changed records, which is regarding the changing of the system by the manager, and clearly know the time of changing of the manager, also, the administrator can delete the changed record altogether, which is according to the changed data after being input a searching status in the searching function of the lower part of the window.

21. The electronic library management system and its method as claimed in claim 20, wherein the system provides the function of setting the system parameters that can set the name, mailbox of the letter sender and the transmit server, if the administrator informed the recommender each related services by email (such as the recommended books have received), then the setting parameters of the mailbox of the sender is needed, supposing that the parameters are not set, the system is send email to the recommender, and the origin of the data is provided by the parameters setting of the maintainer, and chosen by the manager, if not chosen the recommender is unable to recommended such books.

22. The electronic library management system and its method as claimed in claim 20, wherein the system provides the function of changing the password and cancel, which provides the needs of changing the password, when changing the password and mailbox the option must be chosen, if not chosen the system is not able to change, the system is cancelled automatically after being changed, and new password is needed when the next landing.

23. The electronic library management system and its method as claimed in claim 7, wherein if the book is recommended repeatedly, the system is listed the book title in the rank statistics, and provides function of a billboard that is served as the system maintenance connection of the administrator end, at present provides three kinds of billboard: recommended ranking of the recommender, the class and the booklist.

24. The electronic library management system and its method as claimed in claim 16, wherein the system is able to add member data one by one or altogether, if there exists the basic member data that is selected from the member list and collected to the member data, and collected the EXCEL files, if account number or data appeared repeatedly, the system provides two options, one is skipped that is to say according to the original stored member data, and the other is updated that is to say according to the later collected member data.
